(19) United States
(12) Patent Application Publication
(10) Pub. No.: US 2013/0155276 A1
(43) Pub. Date: Jun. 20, 2013

(54) IMAGE CAPTURING APPARATUS, AND CONTROL METHOD AND PROGRAM THEREFOR

(71) Applicant: CANON KABUSHIKI KAISHA, Tokyo (JP)

(72) Inventor: Haruhisa Ueda, Tokyo (JP)

(73) Assignee: CANON KABUSHIKI KAISHA, Tokyo (JP)

(21) Appl. No.: 13/762,120

(22) Filed: Feb. 7, 2013

Related U.S. Application Data
(63) Continuation of application No. PCT/JP2012/075762, filed on Oct. 4, 2012.

(30) Foreign Application Priority Data
Oct. 12, 2011 (JP) 2011-225264
Sep. 19, 2012 (JP) 2012-205997

(51) Int. Cl. H04N 5/232

(52) U.S. Cl. CPC H04N 5/23212
USPC 348/223.1

(57) ABSTRACT

To allow an AF mode to be quickly changed when the AF mode can be changed among a plurality of AF modes.

There are provided an AF range specified area determining unit that sets an AF range in accordance with a touch of a touching object on a display unit and an AF mode determining unit that automatically selects an AF mode in accordance with a face recognition result obtained by an object recognizing unit in the AF range set by the AF range specified area determining unit and a determination result obtained by a focusing portion determining unit, in an AF automatic selection mode in which an AF mode is automatically selected.

### CROSS-REFERENCE TO RELATED APPLICATIONS

This application is a Continuation of International Patent Application No. PCT/JP2012/075762, filed Oct. 4, 2012, which claims the benefit of Japanese Patent Applications No. 2011-225264, filed Oct. 12, 2011 and No. 2012-205997, filed Sep. 19, 2012, all of which are hereby incorporated by reference herein in their entirety.

### TECHNICAL FIELD

The present invention relates to an image capturing apparatus in which, for example, an AF mode can be changed among a plurality of AF modes, and a control method and a program therefor.

### BACKGROUND ART

In recent years, image capturing apparatuses having a function of capturing images, such as a digital camera and a mobile phone with a camera function, have been widely used. These image capturing apparatuses include a display device, such as a liquid crystal display or an organic EL display, and are capable of performing through-the-lens display of a captured image which has been taken by image capturing means through a lens. This allows a user to check composition, exposure, and a point of focus while viewing an image displayed on the display device, and capture an image of an object.

Also, some image capturing apparatuses are provided with a touch panel function in which, for example, a pressure or capacitive touch sensor is superimposed on the display device and to detect a touch of a finger of a photographer, a pen or the like, and the image capturing apparatuses are thereby operated. For example, in an image capturing apparatus disclosed in PTL 1, when a user taps any position in an EVF area that displays a taken image or a captured image of a touch panel superimposed on a display and an AF frame moves, an AE area also moves in such a way that the center of the AE area is located at the center of an AF area. Then, an AF process is performed on the AF area and simultaneously an AE process is performed on the AE area.

### CITATION LIST

### Patent Literature

PTL 1 Japanese Patent Laid-Open No. 2004-205885

However, in the above-described hitherto known technique, when a plurality of AF modes are provided, operations need to be performed, such as the AF mode is set using an operation member and the AF mode is set on a menu screen displayed on a display device, thereby making it difficult to quickly change the AF mode. As a result, at a shutter release opportunity, there is not time to change the AF mode, thereby making it difficult to take a photograph in an optimal AF mode, or a shutter release opportunity is missed while changing the AF mode.

The present invention has been accomplished in order to solve such a problem of the hitherto known technique. Specifically, the present invention has been accomplished in view of the above-described problem, and an object thereof is, for example, to allow an AF mode to be quickly changed when the AF mode can be changed among a plurality of AF modes.

### SUMMARY OF INVENTION

An image capturing apparatus according to the present invention includes display means for displaying an output image from image capturing means for capturing an object image, the display means being capable of detecting a plurality of touches of a touching object, focus detecting means for performing focus detection on the basis of the output image from the image capturing means, focusing portion determining means for determining an area where focusing is possible on the basis of an output from the focus detecting means, object recognizing means for recognizing a certain object on the basis of the output image from the image capturing means, and mode determining means for performing, in accordance with a touch of the touching object on the display means, at least any one of automatic selection of an AF mode from among a plurality of AF modes, automatic selection of an AE mode from among a plurality of AE modes, and automatic selection of a color temperature adjustment mode from among a plurality of color temperature adjustment modes.

Further features of the present invention will become apparent from the following description of exemplary embodiments with reference to the attached drawings.

### BRIEF DESCRIPTION OF DRAWINGS

FIG. 1 is a block diagram illustrating the configuration of a digital camera according to a first embodiment.

FIG. 2A is a front perspective view illustrating the appearance of the digital camera according to the first embodiment.

FIG. 2B is a rear perspective view illustrating the appearance of the digital camera according to the first embodiment.

FIG. 3 is a flowchart illustrating a process performed by the digital camera according to the first embodiment.

FIG. 4 is a flowchart illustrating a process of AF mode determination performed by the digital camera according to the first embodiment.

FIGS. 5A to 5C are schematic views each illustrating an example of a touch operation to specify an AF range in the first embodiment.

FIGS. 6A to 6C are schematic views each illustrating an example of an AF mode selected in accordance with an AF range specified by a touch operation in the first embodiment.

FIG. 7 is a block diagram illustrating the configuration of a digital camera according to a second embodiment.

FIG. 8 is a flowchart illustrating a process performed by the digital camera according to the second embodiment.

FIG. 9 is a flowchart illustrating a process of AE mode determination performed by the digital camera according to the second embodiment.

FIG. 10 is a block diagram illustrating the configuration of a digital camera according to a third embodiment.

FIG. 11 is a flowchart illustrating a process performed by the digital camera according to the third embodiment.

FIG. 12 is a flowchart illustrating a process of color temperature adjustment mode determination performed by the digital camera according to the third embodiment.

FIG. 13 is a flowchart illustrating processes of AF mode determination, AE mode determination, and color temperature adjustment mode determination performed by a digital camera according to a fourth embodiment.

FIG. 14 illustrates a state in which an AF frame, a photometry range frame, and a color temperature evaluation range frame are displayed as a result of the fact that an AF mode, an AE mode, and a color temperature adjustment mode may be independently and automatically selected in a fifth embodiment.

### DESCRIPTION OF EMBODIMENTS

Preferred embodiments of the present invention will be described below with reference to the accompanying drawings.

### First Embodiment

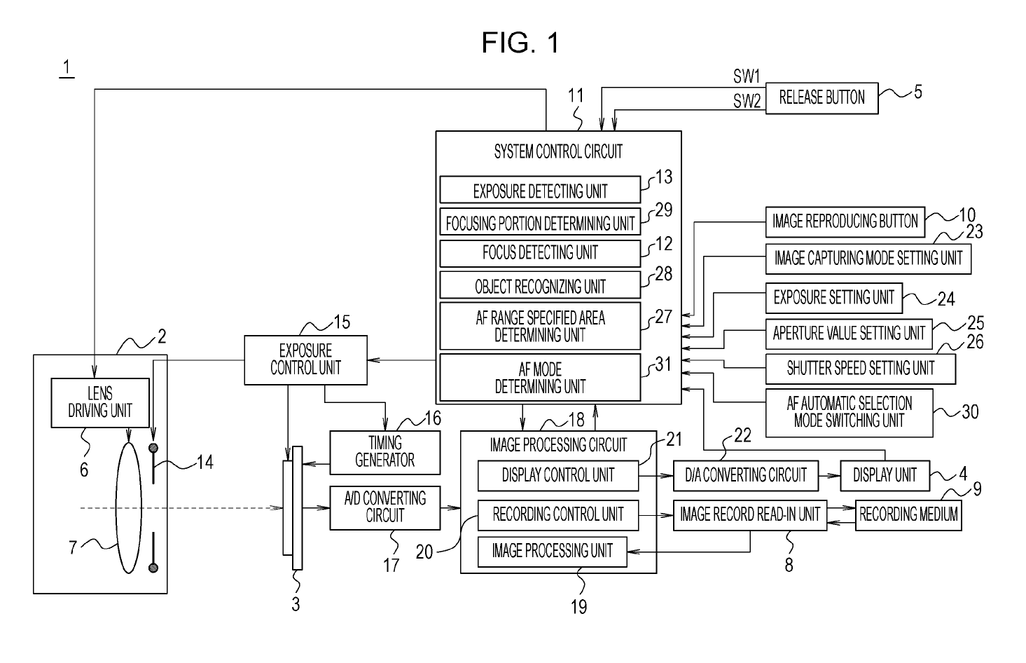

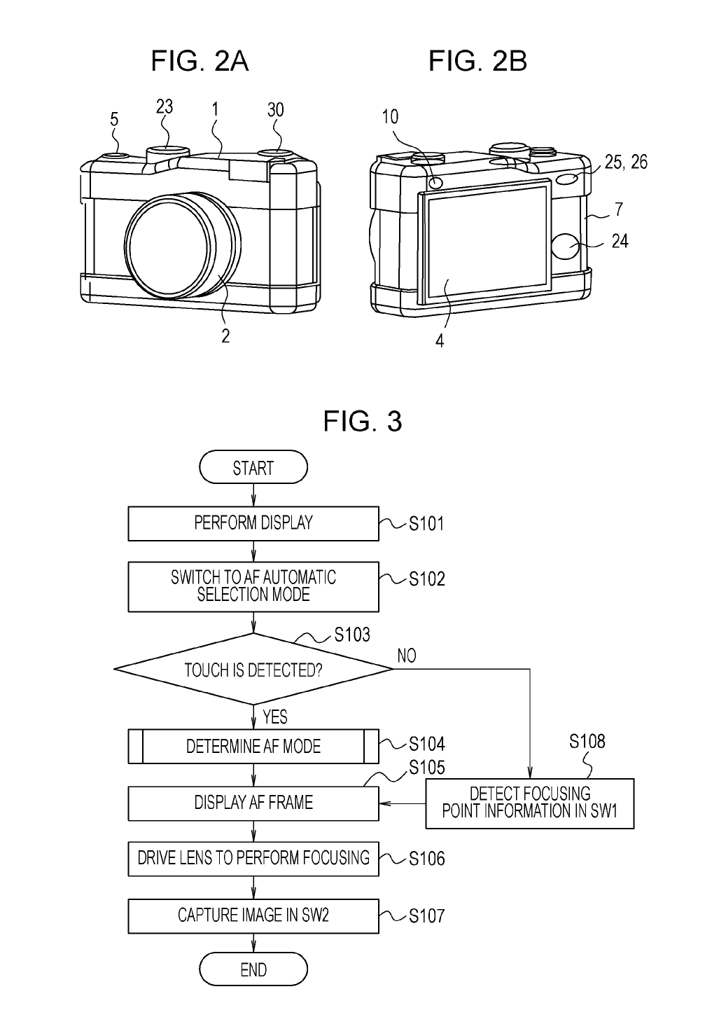

First, the main configuration of a digital camera (hereinafter referred to as a camera) which serves as an image capturing apparatus according to a first embodiment will be described with reference to FIGS. 1, 2A, and 2B. FIG. 1 is a block diagram illustrating the internal configuration of a camera 1 according to this embodiment. FIG. 2A is a front perspective view illustrating the appearance of the camera 1 and FIG. 2B is a rear perspective view illustrating the appearance of the camera 1.

A lens unit 2 including a focus lens 7 is provided on the front surface of the camera 1. Light incident from the lens unit 2 forms an image in an image capturing unit 3 which is inside the camera 1 and is capable of performing focus detection and exposure detection. The image capturing unit 3 allows image capturing to be performed by using an electronic shutter with which electric charge accumulation is controlled and allows output of a through-the-lens image of an object image. The through-the-lens image output from the image capturing unit 3 is displayed on a display unit 4 arranged on the back surface of the camera 1, thereby allowing a photographer to check composition, exposure, and a point of focus. As a shutter, a mechanical shutter may be used in which a light shielding curtain capable of moving is arranged in front of the image capturing unit 3.

When the photographer presses a release button 5 halfway down (SW1 ON), photometry and AF (auto focusing) is started by the image capturing unit 3 and the focus lens 7 is driven by a lens driving unit 6 in the lens unit 2. Next, when the photographer presses the release button 5 all the way down (SW2 ON), the image capturing unit 3 causes the electronic shutter to move so as to capture an image. Then, the image capturing unit 3 performs an exposure operation that starts operations of electric charge accumulation and electric charge readout. Subsequently, captured image data is recorded and retained in a recording medium 9 mounted in an image record read-in unit 8 provided on a side of the camera 1. The recording medium 9 is, for example, a general SD card or CF card. The captured image which is recorded and retained in the recording medium 9 is displayed on the display unit 4 by pressing an image reproducing button 10.

A system control circuit 11 is a circuit that controls the entire camera 1, is composed of a CPU, an MPU, or the like, and controls operations of circuits etc., which will be described below.

The system control circuit 11 functions as a focus detecting unit 12. When AF is started, the system control circuit 11 controls the lens driving unit 6 on the basis of an output image from the image capturing unit 3 so as to drive the focus lens 7 in an optical axis direction and thereby performs focus detection. As a focus detecting method, a known method, such as an image capturing surface phase AF or contrast AF method, may be used. In the image capturing surface phase difference AF method, the image capturing unit 3 includes focus detecting pixels and pupil dividing lenses disposed in front of the focus detecting pixels, which are not illustrated, in addition to image capturing pixels, and performs focus detection on the image capturing surface by utilizing phase difference. In the contrast AF method, focus detection is performed on the basis of a contrast ratio of a captured image. Alternatively, a wobbling method or the like in which the image capturing unit 3 is driven back and forth in an optical axis direction and contrast AF is performed may be used. These focus detecting methods are known and detailed description thereof is therefore omitted.

The system control circuit 11 functions as a focusing portion determining unit 29. When the focus detecting unit 12 detects a contrast value on the basis of the output image from the image capturing unit 3, the system control circuit 11 determines an area where focusing is possible on the basis of the contrast value.

The system control circuit 11 functions as an exposure detecting unit 13. When photometry is started, the system control circuit 11 decides an aperture value of a stop 14 in the lens unit 2 and an electronic shutter speed of the image capturing unit 3 on the basis of the output image from the image capturing unit 3 in accordance with image capturing conditions preset by the photographer. When an image capturing operation is started by pressing the release button 5 all the way down (SW2 ON), the system control circuit 11 causes an exposure control unit 15 to control the stop 14 and an electric charge accumulation time of the electronic shutter to satisfy the decided values.

The system control circuit 11 causes the exposure control unit 15 to output, by using a timing generator 16, a pulse signal which is necessary when the image capturing unit 3 is driven. The image capturing unit 3 performs operations of electric charge accumulation and electric charge readout in accordance with the pulse signal output from the timing generator 16. Electric charge read from the image capturing unit 3 is digitalized by an A/D converting circuit 17 and is transmitted to an image processing circuit 18. The image transmitted to the image processing circuit 18 is subjected to white balance adjustment, image compression processing, and so forth by an image processing unit 19 in the image processing circuit 18, and is then recorded and retained in the recording medium 9 by a recording control unit 20 via the image record read-in unit 8. When the image reproducing button 10 is pressed, the captured image which is recorded and retained in the recording medium 9 is read into a display control unit 21 in the image processing circuit 18 by the image record read-in unit 8, is converted into an analog image by a D/A converting circuit 22, and is displayed on the display unit 4.

The lens unit 2 may have not only the focus lens 7 but also a zoom lens or the like and may have an integrated-type structure or a replaceable separate type structure. Also, a main mirror may be rotatably arranged in front of the image capturing unit 3 so as to constitute an optical viewfinder for introducing light from the lens unit 2 to the eyes of the photographer through a pentaprism and an image-forming lens. Furthermore, a sub mirror is rotatably provided in the main mirror and focus detecting means that operates using phase difference AF may be provided in addition to the focus detecting unit 12 that performs focus detection on the basis of the output image from the image capturing unit 3. The above-described structures are known and detailed description thereof is therefore omitted.

Using an image capturing mode setting unit 23 which is a dial operation member, an image capturing mode can be set. Examples of an image capturing mode which can be set include an auto exposure mode, an aperture-priority exposure mode (Av), a shutter speed priority exposure mode (Tv), a manual mode (M), and a bulb mode (B). When the auto exposure mode is set, the photographer sets a certain appropriate exposure value by using an exposure setting unit 24 which is a dial operation member, and an aperture value and a shutter speed are automatically decided at the time of taking a photograph so as to obtain the appropriate exposure. When the aperture-priority exposure mode (Av), the shutter speed priority exposure mode (Tv), or the manual mode (M) is set, a certain aperture value and a certain shutter speed can be set by using an aperture value setting unit 25 and a shutter speed setting unit 26. When the bulb mode (B) is set, image capturing is started by pressing the release button 5 all the way down (SW2 ON), exposure continues while the release button 5 is being pressed all the way down (SW2 ON), and exposure is ended when the release button 5 is released (SW2 OFF), so that a shutter speed can be decided during image capturing.

In the display unit 4, a capacitive sensor capable of detecting a plurality of touches of a touching object is superimposed on, for example, a liquid crystal or organic EL display panel for displaying an image. When the photographer touches a display area of the display unit 4 with his or her finger, a pen, or the like (hereinafter simply referred to as a “finger”), the location of the touch can be detected. In addition, when the photographer touches the display area of the display unit 4 with a finger and slides the finger over the display area of the display unit 4, the path of the touch can be detected. The capacitive sensor includes an insulating film and an electrode layer having a lattice pattern disposed under the insulating film. When a finger which exhibits conductivity approaches the capacitive sensor, electrostatic induction from the electrode layer to the finger occurs and the electrostatic capacitance of the insulating film therebetween is changed. Then, approach and touch determining means included in the system control circuit 11 reads the change in the electrostatic capacitance on the basis of a potential difference of the electrode layer, thereby allowing detection of the location of the finger. Examples of a touch sensor include an optical type touch sensor which detects reflection of light or variations of light and shade, and a pressure-sensitive type touch sensor which detects pressing force of a finger, other than a capacitive type touch sensor.

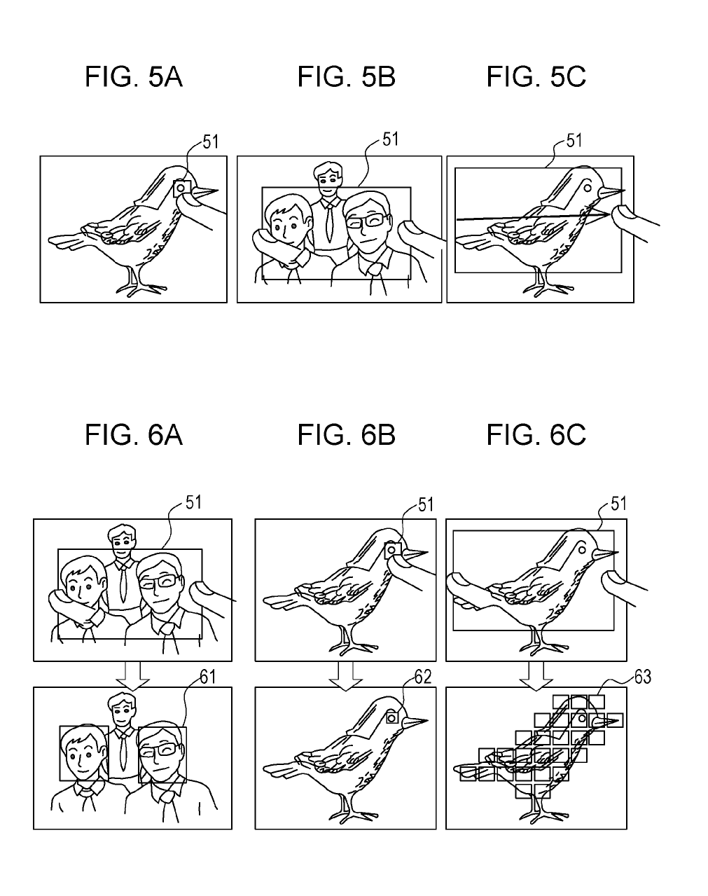

The system control circuit 11 functions as an AF range specified area determining unit 27 which serves as range setting means. When the photographer touches the display area of the display unit 4 with a finger so as to specify an AF range, the system control circuit 11 sets the AF range in accordance with the way in which the finger performs touching. For example, as illustrated in FIG. 5A, when the photographer touches the display area of the display unit 4 with one finger, one local point included in the touched portion is set as an AF range 51. As illustrated in FIG. 5B, when the photographer touches the display area of the display unit 4 with two fingers, an area encompassed by the touched locations of the two fingers or an area including the touched locations of the two fingers is set as an AF range 51. As illustrated in FIG. 5C, when the photographer touches the display area of the display unit 4 with one finger and slides the one finger over the display area of the display unit 4, an area included in the portion over which the finger is slid or an area including the portion over which the finger is slid is set as an AF range 51. Examples of a way of specifying an AF range may include a way of performing specification by performing touching with three or more fingers and a way of performing specification by sliding a finger in a rectangular or circular shape, in addition to the above-described ways.

The system control circuit 11 functions as an object recognizing unit 28 and recognizes an area which corresponds to a face and an entire object image on the basis of the output image from the image capturing unit 3. A face recognizing method is known in which a candidate area for a face within a captured image is extracted on the basis of skin color, the outline of the face, and features of eyes, a nose, etc. to thereby decide a face area on the basis of the feature amount thereof. In addition, a method is known in which a plurality of templates of a face shape are prepared and the correlation between the templates and a captured image is analyzed to thereby decide a face area from the correlation value thereof. As for recognition of an object image, an object image area is extracted by being separated from the background in accordance with color, a shape, and contrast information to thereby recognize the object image. A method for recognizing an object is known and detailed description thereof is therefore omitted.

In the camera 1 according to this embodiment, an AF mode can be changed among a plurality of AF modes. An AF automatic selection mode switching unit 30 is an operation member for changing an AF mode to an AF mode in which a mode is automatically selected. As illustrated in FIGS. 2A and 2B, the AF automatic selection mode switching unit 30 may be provided on the camera 1 as a dedicated operation member or may be provided within setting items which can be changed by using a menu button for changing settings of the entire camera 1. Examples of an AF mode include a face-tracking AF mode, a one-point tracking AF mode, a multiple-point AF mode, and an AF automatic selection mode in which an AF mode is automatically selected in accordance with an AF range 51 specified by a touch operation performed by the photographer.

In the face-tracking AF mode, as illustrated in a lower diagram of FIG. 6A, the object recognizing unit 28 tracks faces as certain objects and AF is performed, and the focus lens 7 is caused to perform an AF operation. In the one-point tracking AF mode, as illustrated in a lower diagram of FIG. 6B, when one local point of an object is selected, the object recognizing unit 28 tracks the portion defined by the local point and AF is performed, and the focus lens 7 is caused to perform an AF operation. In the multiple-point AF mode, as illustrated in a lower diagram of FIG. 6C, AF is performed on an entire object image on which focusing is possible, image capturing conditions, such as an aperture value etc., are controlled so that the entire object image is focused, and the focus lens 7 is caused to perform an AF operation.

The system control circuit 11 functions as an AF mode determining unit 31. When the AF automatic selection mode is set by the AF automatic selection mode switching unit 30, the system control circuit 11 determines an AF mode in accordance with a recognition result of a face obtained by the object recognizing unit 28 in an AF range 51 set by the AF range specified area determining unit 27 and a determination result obtained by the focusing portion determining unit 29, and automatically selects it.

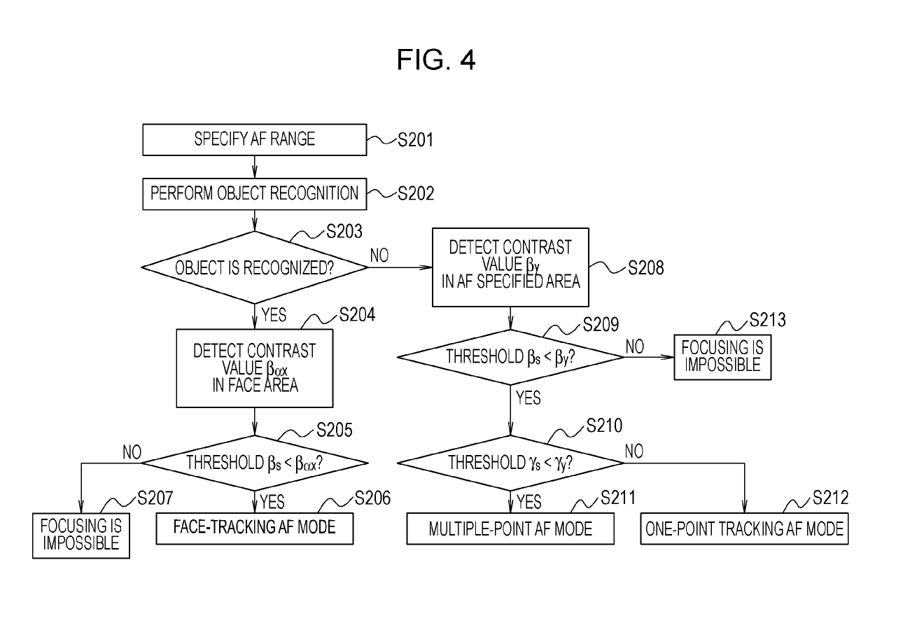

A process performed by the camera 1 according to the first embodiment will be described with reference to the flowcharts in FIGS. 3 and 4. When the photographer turns the camera 1 on, first, the system control circuit 11 displays a through-the-lens image supplied from the image capturing unit 3 on the display unit 4 in step S101. The photographer may check composition, exposure, and a point of focus by looking at the through-the-lens image displayed on the display unit 4.

When the AF automatic selection mode is set by the AF automatic selection mode switching unit 30 in step S102, the system control circuit 11 detects whether or not the photographer has touched the display area of the display unit 4 with a finger so as to specify an AF range in step S103.

When the photographer has not touched the display area with a finger in step S103, the process proceeds to step S108 and normal image capturing is performed. That is, a center or focusing point information obtained by automatic AF frame selection is detected by pressing of the release button 5 (SW1 ON) by the photographer, the process proceeds to step S105, and the system control circuit 11 displays an AF frame on the display unit 4. Then, the system control circuit 11 causes the focus lens 7 to perform an AF operation in step S106. When the photographer presses the release button 5 all the way down (SW2 ON) in step S107, image capturing is performed.

When the photographer has touched the display area with a finger in step S103, the process proceeds to step S104, and the AF mode determining unit 31 determines an AF mode in accordance with an AF range 51 specified by a touch operation performed by the photographer.

FIG. 4 illustrates a process of AF mode determination in step S104. When an AF range 51 is specified in accordance with the above-described ways in which a finger performs touching (step S201), the object recognizing unit 28 performs recognition of an object within the specified AF range 51 (step S202).

When one or a plurality of faces are recognized by object recognition (Yes in step S203), the focus detecting unit 12 detects a contrast value βαₓ of the output image from the image capturing unit 3 corresponding to a face area αₓ (step S204). Then, the focusing portion determining unit 29 compares the contrast value βαₓ detected in step S204 with a preset threshold βₛ (step S205). When the contrast value βαₓ is higher than the threshold βₛ in step S205, the focusing portion determining unit 29 determines that a face area where focusing is possible is present, and the AF mode determining unit 31 determines to use the face-tracking AF mode and automatically selects it (step S206). When the contrast value βαₓ is not higher than the threshold βₛ in step S205, the focusing portion determining unit 29 determines that focusing is impossible (step S207). As illustrated in FIG. 6C, in the case where the photographer specifies a wide range in the display area of the display unit 4 as an AF range 51, when a face is recognized and focusing is possible, it is determined that the face-tracking AF mode is to be used.

When a face is not recognized by object recognition (No in step S203), the focus detecting unit 12 detects a contrast value β_{y} of the output image from the image capturing unit 3 corresponding to the AF range 51 (step S208). Then, the focusing portion determining unit 29 compares the contrast value β_{y} detected in step S208 with the preset threshold βₛ (step S209). In step S209, when an area where the contrast value β_{y} is higher than the threshold βₛ is present, the focusing portion determining unit 29 determines that focusing is possible in the area where the contrast value is higher, and the process proceeds to step S210. In step S209, when an area where the contrast value β_{y} is higher than the threshold βₛ is not present, the focusing portion determining unit 29 determines that focusing is impossible (step S213).

The AF mode determining unit 31 compares a size γ_{y} of the area where focusing is possible with a preset threshold γₛ in step S210. When the size γ_{y} of the area where focusing is possible is larger than the threshold γₛ in step S210, the AF mode determining unit 31 determines to use the multiple-point AF mode and automatically selects it (step S211). As illustrated in FIG. 6C, in the case where the photographer specifies a wide range in the display area of the display unit 4 as an AF range 51, when a face is not recognized, it is determined that the multiple-point AF mode in which AF is performed on an entire area where focusing is possible within the AF range 51 is to be used.

On the other hand, when the size γ_{y} of the area where focusing is possible is not larger than the threshold γₛ in step S210, the AF mode determining unit 31 determines to use the one-point tracking AF mode and automatically selects it (step S212). As illustrated in FIG. 6B, in the case where the photographer touches the display area of the display unit 4 with one finger and specifies one local point as an AF range 51, when a face is not recognized, it is determined that the one-point tracking AF mode is to be used.

Description will now return to FIG. 3. When it is determined that the face-tracking AF mode is to be used in step S104, as illustrated in FIG. 6A, the system control circuit 11 displays an AF frame (face detection AF frame) 61 in a face area where focusing is possible on the display unit 4 in step S105. Then, the system control circuit 11 causes the focus lens 7 to perform an AF operation so as to focus on the face area where focusing is possible in step S106. When the photographer presses the release button 5 all the way down (SW2 ON) in step S107, image capturing is performed.

When it is determined that the one-point tracking AF mode is to be used in step S104, as illustrated in FIG. 6B, the system control circuit 11 displays an AF frame (one-point tracking AF frame) 62 at one point where focusing is possible on the display unit 4 in step S105. Then, the system control circuit 11 causes the focus lens 7 to perform an AF operation so as to focus on the one point where focusing is possible in step S106. When the photographer presses the release button 5 all the way down (SW2 ON) in step S107, image capturing is performed.

When it is determined that the multiple-point AF mode is to be used in step S104, as illustrated in FIG. 6C, the system control circuit 11 displays AF frames at multiple points (multiple-point AF frames) 63 in an entire object image on the display unit 4 in step S105. Then, the system control circuit 11 causes the focus lens 7 to perform an AF operation so as to focus on the entire object image where focusing is possible in step S106. When the photographer presses the release button 5 all the way down (SW2 ON) in step S107, image capturing is performed.

As described above, when the photographer specifies an AF range 51 on the display unit 4 by a touch operation, an AF mode is automatically selected in accordance with the specified AF range 51, thereby allowing the AF mode to be quickly changed. This may prevent a problem of there not being time to change an AF mode at a shutter release opportunity and it being therefore difficult to take a photograph in an optimal AF mode, or of a shutter release opportunity being missed while changing the AF mode.

The present invention is not limited to the above-described AF modes, and various modifications and changes can be made within the scope of the gist of the invention. As an example of an AF mode, a zone AF mode is given in which an AF range is expanded from one local point. For example, when it is determined that the one-point tracking AF mode is to be used in step S104, when a plurality of touches by a finger of the photographer are detected again in substantially the same range on the display unit 4, it may be determined that the zone AF mode is to be used. In this case, an AF frame may be sequentially increased from 1, 5, 9 and 13 points in accordance with the number of the detected touches.

Focus modes, such as a one shot focus mode and a servo focus mode, may be changed. The one shot focus mode is a mode in which a focus is fixed after the lens unit 2 focuses on an object in accordance with an output from the focus detecting unit 12. The servo focus mode is a mode in which focusing on an object is maintained by following a focus when the focused upon object moves. For example, in step S104, when the photographer touches the display unit 4 with a finger so as to specify an object to be focused upon and slides the finger while following the moving object with the finger touching the display unit 4, the AF mode determining unit 31 determines to use the servo focus mode and automatically selects it. When the photographer takes a finger off of the display unit 4 without sliding the finger thereon, the AF mode determining unit 31 determines to use the one shot focus mode and automatically selects it.

### Second Embodiment

In the first embodiment, an example of automatically selecting an AF mode is described; alternatively, an AE (auto exposure) mode may be automatically selected.

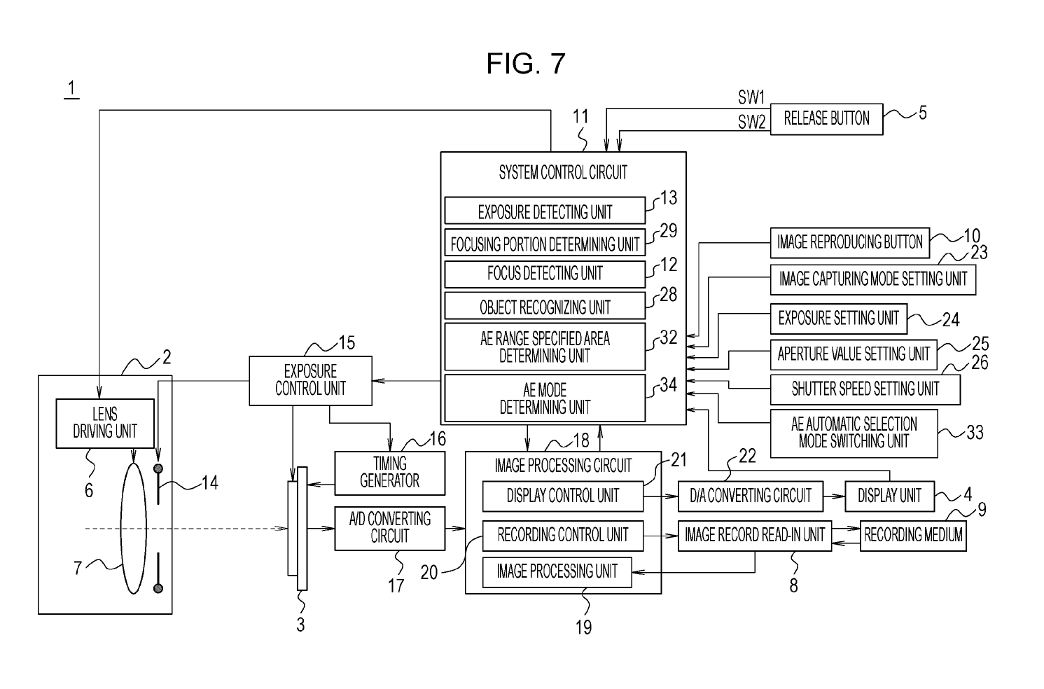

The main configuration of a digital camera (hereinafter referred to as camera) which serves as an image capturing apparatus according to a second embodiment will be described with reference to FIG. 7. Components that are the same as those of the camera 1 according to the first embodiment are denoted by the same reference numerals, and description thereof is omitted.

In the second embodiment, as illustrated in FIG. 7, a camera 1 includes an AE range specified area determining unit 32, an AE automatic selection mode switching unit 33, and an AE mode determining unit 34 in place of the AF range specified area determining unit 27, the AF automatic selection mode switching unit 30, and the AF mode determining unit 31 in the first embodiment. The AE automatic selection mode switching unit 33 may be provided on the camera 1 as a dedicated operation member or may be provided within setting items which can be changed by using a menu button for changing settings of the entire camera 1, like the AF automatic selection mode switching unit 30.

In the second embodiment, the system control circuit 11 functions as the AE range specified area determining unit 32 which serves as range setting means. When a photographer touches a display area of the display unit 4 with a finger so as to specify an AE range, the system control circuit 11 sets the AE range in accordance with the way in which the finger performs touching. For example, when the photographer touches the display area of the display unit 4 with one finger, one local point included in the touched portion is set as an AE range, like the AF range 51 illustrated in FIG. 5A. When the photographer touches the display area of the display unit 4 with two fingers, an area encompassed by the touched locations of the two fingers or an area including the touched locations of the two fingers is set as an AE range, like the AF range 51 illustrated in FIG. 5B. When the photographer touches the display area of the display unit 4 with one finger and slides the one finger over the display area of the display unit 4, an area included in the portion over which the finger is slid or an area including the portion over which the finger is slid is set as an AE range, like the AF range 51 illustrated in FIG. 5C. Examples of a way of specifying an AE range may include a way of performing specification by performing touching with three or more fingers and a way of performing specification by sliding a finger in a rectangular or circular shape, in addition to the above-described ways.

The system control circuit 11 functions as the AE mode determining unit 34. When an AE automatic selection mode is set by the AE automatic selection mode switching unit 33, the system control circuit 11 determines an AE mode in accordance with a recognition result of a face obtained by the object recognizing unit 28 in an AE range set by the AE range specified area determining unit 32 and a determination result obtained by the focusing portion determining unit 29, and automatically selects it. In this embodiment, examples of an AE mode which is determined in the AE automatic selection mode include a face-tracking AE mode in which the object recognizing unit 28 tracks a face of an object and photometry is performed, a one-point tracking AE mode in which the object recognizing unit 28 tracks one local point of an object and photometry is performed, and an object evaluating AE mode in which photometry is performed on an entire object. The exposure detecting unit 13 detects brightness information from an output from the image capturing unit 3 and photometry is performed.

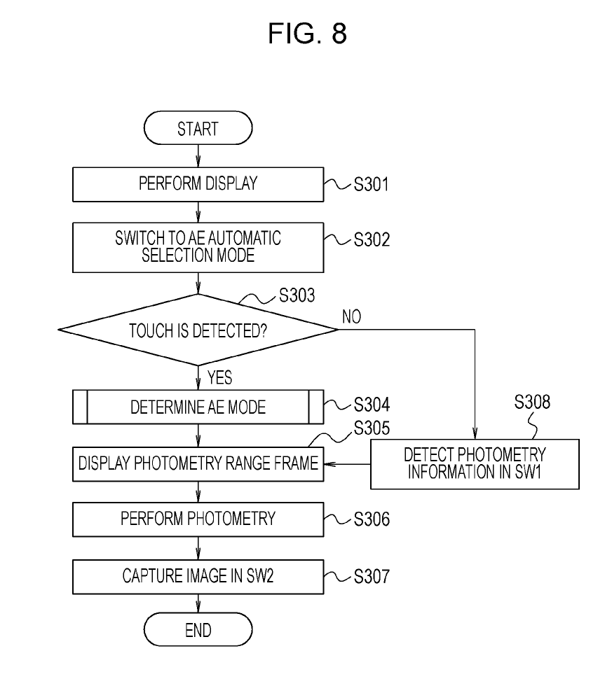

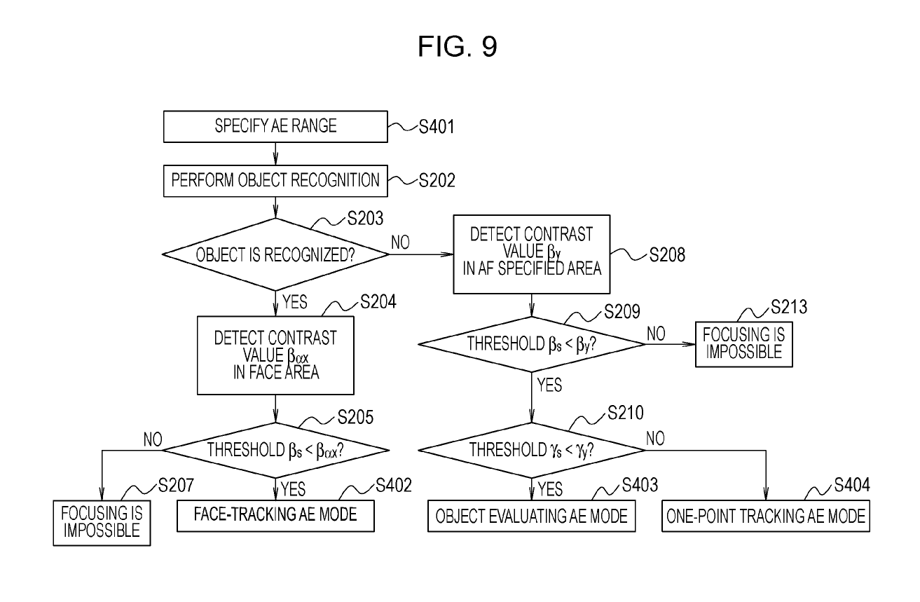

A process performed by the camera 1 according to the second embodiment will be described with reference to the flowcharts in FIGS. 8 and 9. When the photographer turns the camera 1 on, first, the system control circuit 11 displays a through-the-lens image supplied from the image capturing unit 3 on the display unit 4 in step S301. The photographer may check composition, exposure, and a point of focus by looking at the through-the-lens image displayed on the display unit 4.

When the AE automatic selection mode is set by the AE automatic selection mode switching unit 33 in step S302, the system control circuit 11 detects whether or not the photographer has touched the display area of the display unit 4 with a finger so as to specify an AE range in step S303.

When the photographer has not touched the display area with a finger in step S303, the process proceeds to step S308 and normal image capturing is performed. That is, certain photometry information is detected by pressing of the release button 5 (SW1 ON) by the photographer, the process proceeds to step S305, and the system control circuit 11 displays a photometry range frame on the display unit 4. Then, an AE operation is performed in step S306. When the photographer presses the release button 5 all the way down (SW2 ON) in step S307, image capturing is performed.

When the photographer has touched the display area with a finger in step S303, the process proceeds to step S304, and the AE mode determining unit 34 determines an AE mode in accordance with an AE range specified by a touch operation performed by the photographer.

FIG. 9 illustrates a process of AE mode determination in step S304. The same processes as those in the flowchart in FIG. 4 described in the first embodiment are denoted by the same reference numerals, and description thereof is omitted. When an AE range is specified in accordance with the above-described ways in which a finger performs touching (step S401), determination in steps S202 to S205 and steps S208 to S210 is performed. When a contrast value βαₓ is higher than a threshold βₛ in step S205, it is determined that a face area where focusing is possible is present, and the AE mode determining unit 34 determines to use the face-tracking AE mode and automatically selects it (step S402). When a size γ_{y} of an area where focusing is possible is larger than a threshold γₛ in step S210, the AE mode determining unit 34 determines to use the object evaluating AE mode and automatically selects it (step S403). On the other hand, when the size γ_{y} of the area where focusing is possible is not larger than the threshold γₛ in step S210, the AE mode determining unit 34 determines to use the one-point tracking AE mode and automatically selects it (step S404).

Description will now return to FIG. 8. When it is determined that the face-tracking AE mode is to be used in step S304, the system control circuit 11 displays a photometry range frame in a face area where focusing is possible on the display unit 4 in step S305, like the AF frame (face detection AF frame) 61 illustrated in FIG. 6A. Then, an AE operation is performed on the face area where focusing is possible in step S306. When the photographer presses the release button 5 all the way down (SW2 ON) in step S307, image capturing is performed.

When it is determined that the one-point tracking AE mode is to be used in step S304, the system control circuit 11 displays a photometry range frame at one point where focusing is possible on the display unit 4 in step S305, like the AF frame (one-point tracking AF frame) 62 illustrated in FIG. 6B. Then, an AE operation is performed on the one point where focusing is possible in step S306. When the photographer presses the release button 5 all the way down (SW2 ON) in step S307, image capturing is performed.

When it is determined that the object evaluating AE mode is to be used in step S304, the system control circuit 11 displays photometry range frames at multiple points in an entire object image on the display unit 4 in step S305, like the AF frames (multiple-point AF frames) 63 illustrated in FIG. 6C. Then, an AE operation is performed on the entire object image where focusing is possible in step S306. When the photographer presses the release button 5 all the way down (SW2 ON) in step S307, image capturing is performed.

### Third Embodiment

An example of automatically selecting an AF mode in the first embodiment and an example of automatically selecting an AE mode in the second embodiment are described; alternatively, a color temperature adjustment mode may be automatically selected.

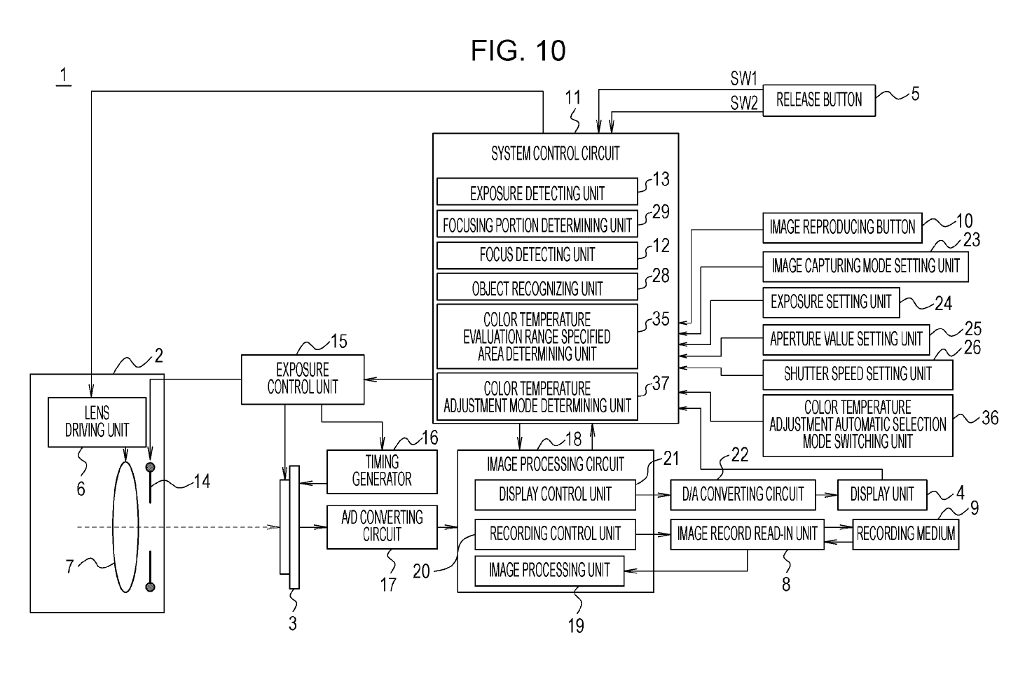

The main configuration of a digital camera (hereinafter referred to as camera) which serves as an image capturing apparatus according to a third embodiment will be described with reference to FIG. 10. Components that are the same as those of the camera 1 according to the first embodiment are denoted by the same reference numerals, and description thereof is omitted.

In the third embodiment, as illustrated in FIG. 10, a camera 1 includes a color temperature evaluation range specified area determining unit 35, a color temperature adjustment automatic selection mode switching unit 36, and a color temperature adjustment mode determining unit 37 in place of the AF range specified area determining unit 27, the AF automatic selection mode switching unit 30, and the AF mode determining unit 31 in the first embodiment. The color temperature adjustment automatic selection mode switching unit 36 may be provided on the camera 1 as a dedicated operation member or may be provided within setting items which can be changed by using a menu button for changing settings of the entire camera 1, like the AF automatic selection mode switching unit 30 and the AE automatic selection mode switching unit 33.

In the third embodiment, the system control circuit 11 functions as the color temperature evaluation range specified area determining unit 35 which serves as range setting means. When a photographer touches a display area of the display unit 4 with a finger so as to specify a color temperature evaluation range, the system control circuit 11 sets the color temperature evaluation range in accordance with the way in which the finger performs touching. For example, when the photographer touches the display area of the display unit 4 with one finger, one local point included in the touched portion is set as a color temperature evaluation range, like the AF range 51 illustrated in FIG. 5A. When the photographer touches the display area of the display unit 4 with two fingers, an area encompassed by the touched locations of the two fingers or an area including the touched locations of the two fingers is set as a color temperature evaluation range, like the AF range 51 illustrated in FIG. 5B. When the photographer touches the display area of the display unit 4 with one finger and slides the one finger over the display area of the display unit 4, an area included in the portion over which the finger is slid or an area including the portion over which the finger is slid is set as a color temperature evaluation range, like the AF range 51 illustrated in FIG. 5C. Examples of a way of specifying a color temperature evaluation range may include a way of performing specification by performing touching with three or more fingers and a way of performing specification by sliding a finger in a rectangular or circular shape, in addition to the above-described ways.

The system control circuit 11 functions as the color temperature adjustment mode determining unit 37. When a color temperature adjustment automatic selection mode is set by the color temperature adjustment automatic selection mode switching unit 36, the system control circuit 11 determines a color temperature adjustment mode in accordance with a recognition result of a face obtained by the object recognizing unit 28 in a color temperature evaluation range set by the color temperature evaluation range specified area determining unit 35 and a determination result obtained by the focusing portion determining unit 29, and automatically selects it. In this embodiment, examples of a color temperature adjustment mode which is determined in the color temperature adjustment automatic selection mode include a face-tracking color temperature adjustment mode in which the object recognizing unit 28 tracks a face of an object and a color temperature is adjusted in accordance with color of skin, a light source color temperature adjustment mode in which the exposure detecting unit 13 detects a light source with high brightness and a color temperature is adjusted in accordance with color of the light source, and an auto color temperature adjustment mode in which a color temperature is adjusted in accordance with a substantially average color temperature of an entire object. A color temperature is evaluated and adjusted by the image processing circuit 18 in accordance with color information of an output from the image capturing unit 3.

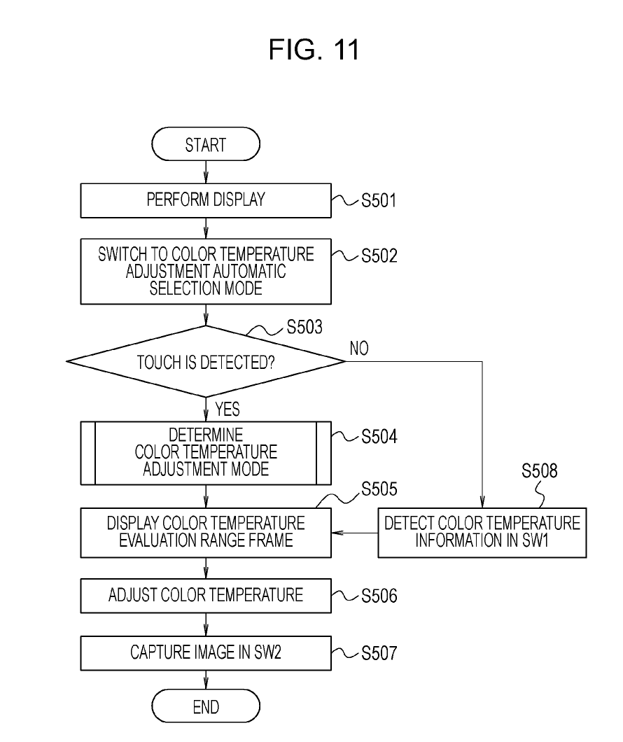

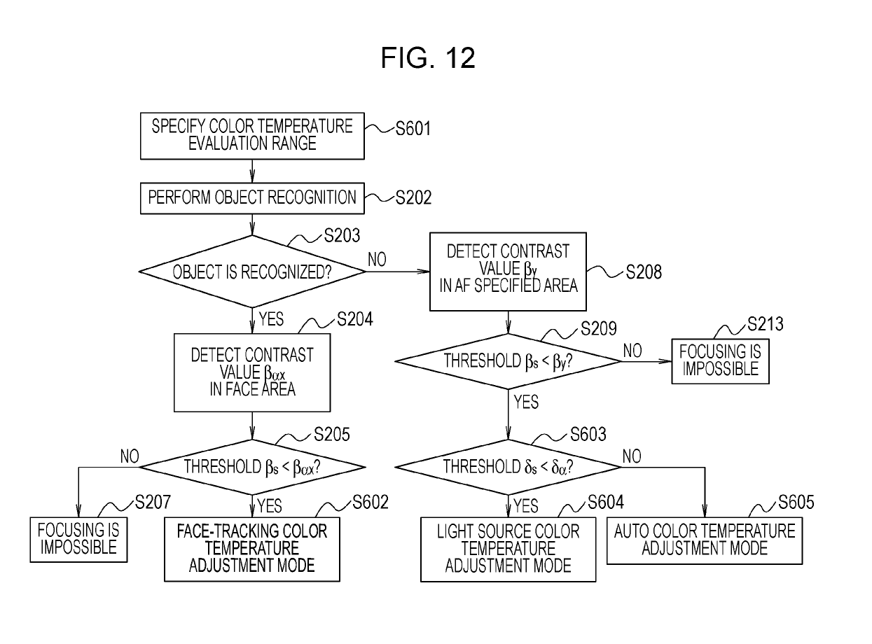

A process performed by the camera 1 according to the third embodiment will be described with reference to the flowcharts in FIGS. 11 and 12. When the photographer turns the camera 1 on, first, the system control circuit 11 displays a through-the-lens image supplied from the image capturing unit 3 on the display unit 4 in step S501. The photographer may check composition, exposure, and a point of focus by looking at the through-the-lens image displayed on the display unit 4.

When the color temperature adjustment automatic selection mode is set by the color temperature adjustment automatic selection mode switching unit 36 in step S502, the system control circuit 11 detects whether or not the photographer has touched the display area of the display unit 4 with a finger so as to specify a color temperature evaluation range in step S503.

When the photographer has not touched the display area with a finger in step S503, the process proceeds to step S508 and normal image capturing is performed. That is, certain color temperature information is detected by pressing of the release button 5 (SW1 ON) by the photographer, the process proceeds to step S505, and the system control circuit 11 displays a color temperature evaluation range frame on the display unit 4. Then, a color temperature adjustment operation is performed in step S506. When the photographer presses the release button 5 all the way down (SW2 ON) in step S507, image capturing is performed.

When the photographer has touched the display area with a finger in step S503, the process proceeds to step S504, and the color temperature adjustment mode determining unit 37 determines a color temperature adjustment mode in accordance with a color temperature evaluation range specified by a touch operation performed by the photographer.

FIG. 12 illustrates a process of color temperature adjustment mode determination in step S504. The same processes as those in the flowchart in FIG. 4 described in the first embodiment are denoted by the same reference numerals, and description thereof is omitted. When a color temperature evaluation range is specified in accordance with the above-described ways in which a finger performs touching (step S601), determination in steps S202 to S205 and steps S208 and S209 is performed. When a contrast value βαₓ is higher than a threshold βₛ in step S205, it is determined that a face area where focusing is possible is present, and the color temperature adjustment mode determining unit 37 determines to use the face-tracking color temperature adjustment mode and automatically selects it (step S602).

In step S209, when an area where a contrast value β_{y} is higher than a threshold βₛ is present, it is determined that focusing is possible in the area where the contrast value is higher, and the process proceeds to step S603. The color temperature adjustment mode determining unit 37 compares brightness δα in an area where focusing is possible with a preset threshold δₛ in step S603. When the brightness δα in the area where focusing is possible is higher than the threshold δₛ in step S603, the color temperature adjustment mode determining unit 37 determines to use the light source color temperature adjustment mode and automatically selects it (step S604). On the other hand, when the brightness δα in the area where focusing is possible is not higher than the threshold δₛ in step S603, the color temperature adjustment mode determining unit 37 determines to use the auto color temperature adjustment mode and automatically selects it (step S605).

Description will now return to FIG. 11. When it is determined that the face-tracking color temperature adjustment mode is to be used in step S504, the system control circuit 11 displays a color temperature evaluation range frame in a face area where focusing is possible on the display unit 4 in step S505, like the AF frame (face detection AF frame) 61 illustrated in FIG. 6A. Then, color temperature evaluation is performed on the face area where focusing is possible and a color temperature adjustment operation is performed in step S506. When the photographer presses the release button 5 all the way down (SW2 ON) in step S507, image capturing is performed.

When it is determined that the auto color temperature adjustment mode is to be used in step S504, the system control circuit 11 expands a color temperature evaluation range throughout an object so as to display a color temperature evaluation range frame on the display unit 4 in step S505. Then, a substantially average color temperature of the object in the color temperature evaluation range frame is detected and a color temperature adjustment operation is performed in step S506. When the photographer presses the release button 5 all the way down (SW2 ON) in step S507, image capturing is performed.

When it is determined that the light source color temperature adjustment mode is to be used in step S504, the exposure detecting unit 13 detects a color temperature of a light source portion with high brightness in a color temperature evaluation range and the system control circuit 11 displays a color temperature evaluation range frame on the display unit 4 in step S505. Then, a color temperature adjustment operation is performed in step S506. When the photographer presses the release button 5 all the way down (SW2 ON) in step S507, image capturing is performed.

### Fourth Embodiment

An example of automatically selecting an AF mode in the first embodiment, an example of automatically selecting an AE mode in the second embodiment, and an example of automatically selecting a color temperature adjustment mode in the third embodiment are described; alternatively, these operations may be operatively associated with one another.

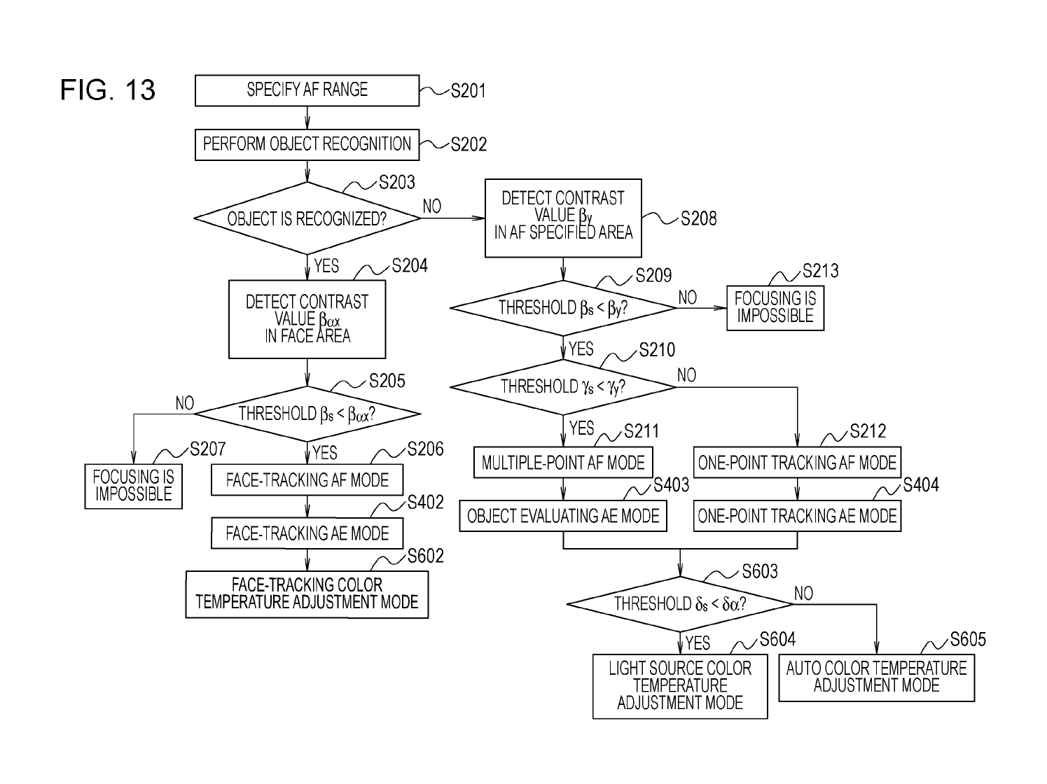

For example, as illustrated in FIG. 13, a face-tracking AF mode, a multiple-point AF mode, or a one-point tracking AF mode is determined and is automatically selected (steps S201 to S212), as in the first embodiment.

Then, when the face-tracking AF mode is automatically selected in step S206, a face-tracking AE mode is automatically selected in which a face area where focusing is possible serves as a photometry range frame (step S402). Additionally, a face-tracking color temperature adjustment mode is automatically selected in which the face area where focusing is possible serves as a color temperature evaluation range frame (step S602).

On the other hand, when the multiple-point AF mode is automatically selected in step S211, an object evaluating AE mode is automatically selected in which photometry range frames at multiple points are set in an entire object image (step S403). When the one-point tracking AF mode is automatically selected in step S212, a one-point tracking AE mode is automatically selected in which one point where focusing is possible serves as a photometry range frame (step S404).

Then, when the object evaluating AE mode and the one-point tracking AE mode are automatically selected, the process proceeds to step S603, and brightness δα in the area where focusing is possible is compared with a preset threshold δₛ. When the brightness δα in the area where focusing is possible is higher than the threshold δₛ in step S603, it is determined that a light source color temperature adjustment mode is to be used and it is automatically selected (step S604). When the brightness δα in the area where focusing is possible is not higher than the threshold δₛ, it is determined that an auto color temperature adjustment mode is to be used and it is automatically selected (step S605).

### Fifth Embodiment

In the fourth embodiment, an example is described in which an AE mode and a color temperature adjustment mode are also automatically selected in association with automatic selection of an AF mode; alternatively, in a series of operations, an AF mode, an AE mode, and a color temperature adjustment mode may be independently and automatically selected.

In this embodiment, in order that, in a series of operations, an AF mode, an AE mode, and a color temperature adjustment mode may be independently and automatically selected, the system control circuit 11 is provided with a function as touch order detecting means for detecting the order of touches when a photographer touches the display unit 4 with a finger multiple times.

In this embodiment, an example in which an AF mode and an AE mode are independently and automatically selected in sequence will be described with reference to FIGS. 3 and 8.

It is detected whether or not a finger has touched a display area of the display unit 4 (step S103 in FIG. 3) with a through-the-lens image supplied from the image capturing unit 3 displayed on the display unit 4. When a touch of the finger is detected, processes of steps S104, S105, and S106 in FIG. 3 are performed.

Subsequently, before the photographer presses the release button 5 all the way down (SW2 ON), it is detected whether or not a finger has touched the display area of the display unit 4 (step S303 in FIG. 8) under certain conditions. When a touch of the finger is detected, processes of steps S304, S305, and S306 in FIG. 8 are performed. As a certain condition, for example, it may be made a condition that a touch of another finger is made (step S303) while the touch of a first finger is still being maintained (step S103). Also, it may be made a condition that a second touch of a finger is made within a certain period of time (step S303) after a first touch of the finger is made (step S103) and released.

Afterwards, when the photographer presses the release button 5 all the way down (SW2 ON), image capturing is performed.

In this embodiment, an example in which an AF mode and an AE mode are independently and automatically selected is described; alternatively, any combinations of an AF mode, an AE mode, and a color temperature adjustment mode may be independently and automatically selected. The order of the automatic selection may be changed in, for example, menu setting.

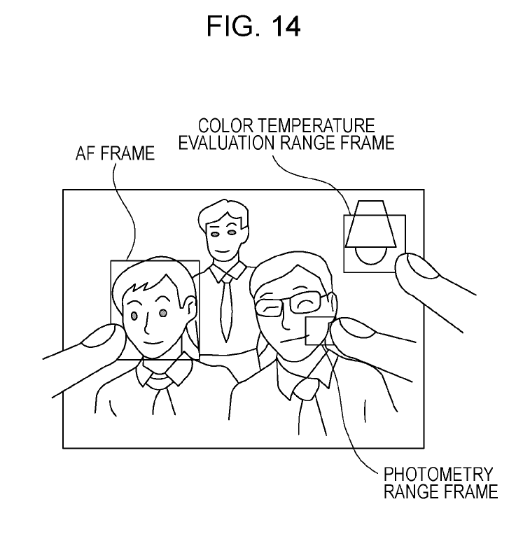

FIG. 14 illustrates a state in which an AF frame, a photometry range frame, and a color temperature evaluation range frame are displayed as a result of the fact that an AF mode, an AE mode, and a color temperature adjustment mode may be independently and automatically selected.

### Sixth Embodiment

As described in the first embodiment and illustrated in FIG. 5A, when a photographer touches a display area of the display unit 4 with one finger, one local point included in the touched portion is set as an AF range 51. At this time, the system control circuit 11 detects a touch time T.

Subsequently, when the focus lens 7 is caused to perform an AF operation (step S106), a driving time until when the focus lens 7 has focused is set in accordance with the touch time T. For example, a driving time until when the focus lens 7 has focused is set to be the touch time T.

In this embodiment, an AF mode is described as an example; however, this embodiment can also be applied to automatic selection of an AE mode and a color temperature adjustment mode. When an AE mode is automatically selected, a changing time of exposure amount of the image capturing unit 3 controlled by the exposure control unit 15 is set in accordance with a touch time T and photometry is performed. When a color temperature adjustment mode is automatically selected, a color temperature adjusting (changing) time controlled by the image processing circuit 18 is set in accordance with a touch time T and a color temperature of an output image from the image capturing unit 3 is adjusted.

As in this embodiment, a driving time until when the focus lens 7 has focused is set in accordance with a touch time T, thereby, for example, when a moving image is shot, allowing a user to easily control slow focusing as in a movie.

In the above, preferred embodiments of the present invention are described; however, the present invention is not limited to these embodiments and various modifications and changes can be made within the scope of the gist of the invention.

### Other Embodiments

The present invention may also be implemented by executing the following process: software (a program) implementing the functions of the foregoing embodiments is supplied to a system or apparatus via a network or various storage media, and a computer (CPU, MPU, or the like) in the system or apparatus reads and executes the program.

In addition, in the above-described embodiments, the configuration in which a CPU executes processes in a software manner is described. However, at least some of the processes may be executed by hardware (ASIC, programmable logic, etc.).

According to the present invention, an AF mode is automatically selected from among, for example, a plurality of AF modes in accordance with a touch of a touching object on the display means, thereby allowing the AF mode to be quickly changed.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1. An image capturing apparatus comprising:
display means for displaying an output image from image capturing means for capturing an object image, the display means being capable of detecting a plurality of touches of a touching object;
focus detecting means for performing focus detection on the basis of the output image from the image capturing means;
focusing portion determining means for determining an area where focusing is possible on the basis of an output from the focus detecting means;
object recognizing means for recognizing a certain object on the basis of the output image from the image capturing means; and
mode determining means for performing, in accordance with a touch of the touching object on the display means, at least any one of automatic selection of an AF mode from among a plurality of AF modes, automatic selection of an AE mode from among a plurality of AE modes, and automatic selection of a color temperature adjustment mode from among a plurality of color temperature adjustment modes.

2. The image capturing apparatus according to claim 1, further comprising:
range setting means for setting a range in accordance with a touch of the touching object on the display means,
wherein the mode determining means performs automatic selection in accordance with a recognition result of the certain object obtained by the object recognizing means in the range set by the range setting means and a determination result obtained by the focusing portion determining means.

3. The image capturing apparatus according to claim 2, wherein, when one touching object touches the display means, the range setting means sets one local point included in a touched location of the one touching object as a range.

4. The image capturing apparatus according to claim 2, wherein, when a plurality of touching objects touch the display means, the range setting means sets an area encompassed by a plurality of touched locations of the plurality of touching objects or an area including the plurality of touched locations as a range.

5. The image capturing apparatus according to claim 2, wherein, when the touching object touches and slides over the display means, the range setting means sets an area included in a portion over which the touching object slides or an area including the portion over which the touching object slides as a range.

6. The image capturing apparatus according to claim 2, wherein the mode determining means is AF mode determining means, and, when the certain object is recognized by the object recognizing means in the range set by the range setting means, the mode determining means automatically selects a tracking AF mode in which the certain object where focusing is possible is tracked and AF is performed.

7. The image capturing apparatus according to claim 2, wherein the mode determining means is AF mode determining means, and, in the case where the certain object is not recognized by the object recognizing means in the range set by the range setting means, when a size of the area where focusing is possible determined by the focusing portion determining means is larger than a certain threshold, the mode determining means automatically selects a multiple-point AF mode in which AF is performed on an entire object image, and, when the size of the area where focusing is possible determined by the focusing portion determining means is not larger than the certain threshold, the mode determining means automatically selects a one-point tracking AF mode in which one local point of an object is tracked and AF is performed.

8. The image capturing apparatus according to claim 7, wherein, in the case where the mode determining means determines to use the one-point tracking AF mode, when a plurality of touches of the touching object are detected again in substantially the same range on the display means, it is determined that a zone AF mode is to be used, and an AF frame which is displayed on the display means is expanded in accordance with the number of detected touches.

9. The image capturing apparatus according to claim 1,
wherein the mode determining means is AF mode determining means, and the mode determining means automatically selects a one shot focus mode in which a focus is fixed after focusing is performed on an object and a servo focus mode in which focusing on an object is maintained by following a focus when the focused upon object moves, and
wherein the mode determining means automatically selects the servo focus mode when the touching object is caused to touch the display means so as to specify an object to be focused upon and is slid while following the moving object with the touching object touching the display means, and automatically selects the one shot focus mode when the touching object is taken off of the display means without being slid.

10. The image capturing apparatus according to claim 2, wherein the mode determining means is AE mode determining means, and, when the certain object is recognized by the object recognizing means in the range set by the range setting means, the mode determining means automatically selects a tracking AE mode in which the certain object where focusing is possible is tracked and AE is performed.

11. The image capturing apparatus according to claim 2, wherein the mode determining means is AE mode determining means, and, in the case where the certain object is not recognized by the object recognizing means in the range set by the range setting means, when a size of the area where focusing is possible determined by the focusing portion determining means is larger than a certain threshold, the mode determining means automatically selects an object evaluating AE mode in which AE is performed on an entire object image, and, when the size of the area where focusing is possible determined by the focusing portion determining means is not larger than the certain threshold, the mode determining means automatically selects a one-point tracking AE mode in which one local point of an object is tracked and AE is performed.

12. The image capturing apparatus according to claim 2, wherein the mode determining means is color temperature adjustment mode determining means, and, when the certain object is recognized by the object recognizing means in the range set by the range setting means, the mode determining means automatically selects a tracking color temperature adjustment mode in which the certain object where focusing is possible is tracked and color temperature adjustment is performed.

13. The image capturing apparatus according to claim 2, wherein the mode determining means is color temperature adjustment mode determining means, and, in the case where the certain object is not recognized by the object recognizing means in the range set by the range setting means, when brightness of the area where focusing is possible determined by the focusing portion determining means is higher than a certain threshold, the mode determining means automatically selects a light source color temperature adjustment mode in which a light source with high brightness is detected and a color temperature is adjusted in accordance with color of the light source, and, when the brightness of the area where focusing is possible determined by the focusing portion determining means is not higher than the certain threshold, the mode determining means automatically selects an auto color temperature adjustment mode in which a color temperature is adjusted in accordance with a substantially average color temperature of an entire object.

14. The image capturing apparatus according to claim 1, wherein the focusing portion determining means determines an area where focusing is possible on the basis of a contrast value, detected by the focus detecting means, of the output image from the image capturing means.

15. A control method for an image capturing apparatus including display means for displaying an output image from image capturing means for capturing an object image, the display means being capable of detecting a plurality of touches of a touching object, the control method comprising:
a focus detecting step of performing focus detection on the basis of the output image from the image capturing means;
a focusing portion determining step of determining an area where focusing is possible on the basis of an output in the focus detecting step;
an object recognizing step of recognizing a certain object on the basis of the output image from the image capturing means; and
a mode determining step of performing, in accordance with a touch of the touching object on the display means, at least any one of automatic selection of an AF mode from among a plurality of AF modes, automatic selection of an AE mode from among a plurality of AE modes, and automatic selection of a color temperature adjustment mode from among a plurality of color temperature adjustment modes.

16. A program for controlling an image capturing apparatus including display means for displaying an output image from image capturing means for capturing an object image, the display means being capable of detecting a plurality of touches of a touching object, the program causing a computer to function as:
focus detecting means for performing focus detection on the basis of the output image from the image capturing means;
focusing portion determining means for determining an area where focusing is possible on the basis of an output from the focus detecting means;
object recognizing means for recognizing a certain object on the basis of the output image from the image capturing means; and
mode determining means for performing, in accordance with a touch of the touching object on the display means, at least any one of automatic selection of an AF mode from among a plurality of AF modes, automatic selection of an AE mode from among a plurality of AE modes, and automatic selection of a color temperature adjustment mode from among a plurality of color temperature adjustment modes.
